(19) United States
(12) Patent Application Publication
(10) Pub. No.: US 2018/0065697 A1
(43) Pub. Date: Mar. 8, 2018

(54) PEDAL DRIVEN STANDING STYPE BICYCLE

(71) Applicant: Kevin John Badura, Buford, GA (US)

(72) Inventor: Kevin John Badura, Buford, GA (US)

(21) Appl. No.: 15/633,499

(22) Filed: Jun. 26, 2017

Related U.S. Application Data
(63) Continuation of application No. 62/495,149, filed on Sep. 6, 2016.

(51) Int. Cl. B62K 3/00; B62K 3/02; B62K 19/10

(52) U.S. Cl. CPC B62K 3/002; B62K 19/02; B62K 19/10; B62K 3/02

(57) ABSTRACT

A bicycle apparatus comprising a front wheel, an elongated fork having a first end and a second end, wherein the front wheel is attached to the second end of the fort, a handle bar, wherein the handle bar is freely attached to the first end of the fork to allow a rider to steer the bicycle, a frame attached to the fork distal to the first end, a rear wheel attached to the frame, a drivetrain, wherein the drivetrain is connected to the frame and the rear wheel and allows the rider to propel the bicycle forward, wherein, the plurality of elongated tubes of the frame position the handle bars relate to the drivetrain so that a rider is in the orthostatic position.

### BACKGROUND OF THE INVENTION

The present invention relates to bicycle, and more particularly to pedal driven standing bicycle.

Bicycles are one of the more popular means for transportation. Various types of bicycles are in existence, for instance, recreational sports, mountain climbing, road bike, and the like. Most of these bicycles are designed for the rider to be sitting down on a seat while using the bicycle and steering with the handle bars. Conventional bicycles are equipped with a seat due to its running method of rotating the pedals. In the case of riding a bicycle sitting on a seat, a person can mainly expect to exercise the muscle of the lower half of the body. Bicycles are widely used not just for transportation purposes but also for leisure sports.

A rider can use a bicycle in a standing position to enable a whole-body workout by pedaling in a standing posture. This enables the whole body to work out by which the bicycle is ridden by the using one's legs to pedal and using their arms on the handle bar. However, with the current bicycle design, it is sometimes uncomfortable to use the bicycle in the standing position because the handle bars are not positioned correctly. The seat may also be in an uncomfortable position when the rider is standing. Many people find this up and down movement of the pedals to be more comfortable than some of the various other bicycle pedaling setups.

An object of the present invention is to create a bicycle that is more ergonomically designed to be used in the standing position to provide a whole-body workout for the rider. The present invention provides a bicycle that has an up and down movement with the pedals while also providing an ergonomic position of the rider to allow for more comfortable rides.

### SUMMARY

Aspects of an embodiment of the present invention disclose a bicycle, comprising a front wheel, an elongated fork having a first end and a second end, wherein the front wheel is attached to the second end of the fort, a handle bar, wherein the handle bar is freely attached to the first end of the fork to allow a rider to steer the bicycle, a frame attached to the fork distal to the first end, a rear wheel attached to the frame, a drivetrain, wherein the drivetrain is connected to the frame and the rear wheel and allows the rider to propel the bicycle forward, wherein, the plurality of elongated tubes of the frame position the handle bars relate to the drivetrain so that a rider is in the orthostatic position.

The bicycle frame is comprised of a fork tube, a front upper tube having a first end and second end, wherein the first end of the front upper tube attached to the fork tube, a front lower tube having a first end and a second end, wherein the first end of the front lower tube attached to the fork tube, a vertical tube having a first end and a second end, wherein the second end of the front upper tube is attached to the first end of the vertical tube and the second end of the front lower tube is attached to the second end of the vertical tube, a rear upper tube having a first end and a second end, wherein the first end of the rear upper tube is attached to the first end of the vertical tube, and a rear lower tube having a first end and a second end, wherein the first end of the rear lower tube is attached to the second end of the vertical member and the second end of the rear lower tube is attached to the second end of the rear upper tube, and this design requires the rider to be in an orthostatic position for improved control, stability, and an increase in range of motion.

### BRIEF DESCRIPTION OF THE DRAWINGS

FIG. 1 depicts an isometric view of a standing pedal bicycle, in accordance with one embodiment of the present invention.

FIG. 2 depicts a side view of the standing pedal bicycle, in accordance with one embodiment of the present invention.

FIG. 3 depicts a side view of the standing pedal bicycle, in accordance with another embodiment of the present invention.

FIG. 4 depicts a front view of the standing pedal bicycle with a rider, in accordance with one embodiment of the present invention.

FIG. 5 depicts a side view of the standing pedal bicycle with a rider, in accordance with one embodiment of the present invention.

### DETAILED DESCRIPTION OF THE INVENTION

The present invention relates to a bicycle which enables a rider to remain in an orthostatic position or standing posture while operating the bicycle. This is helpful for riders that have a difficulty sitting for an extended time period, riders who want a full body workout while using a bicycle, or riders who prefer to be in the orthostatic position.

One advantage of the bicycle is the mounting and dismounting position. The mounting position is more ergonomic because of the handle bar height and the lack of a frame which interfere with the rider. This allows the rider to use the pedals as a base support to pull and propel the rider forward. At the same time the rider is using the handle bars to direct the stability and control of the bike more efficiently. While cycling in the standing position the rider's equilibrium is centered allowing the rider to be more stable when in motion.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

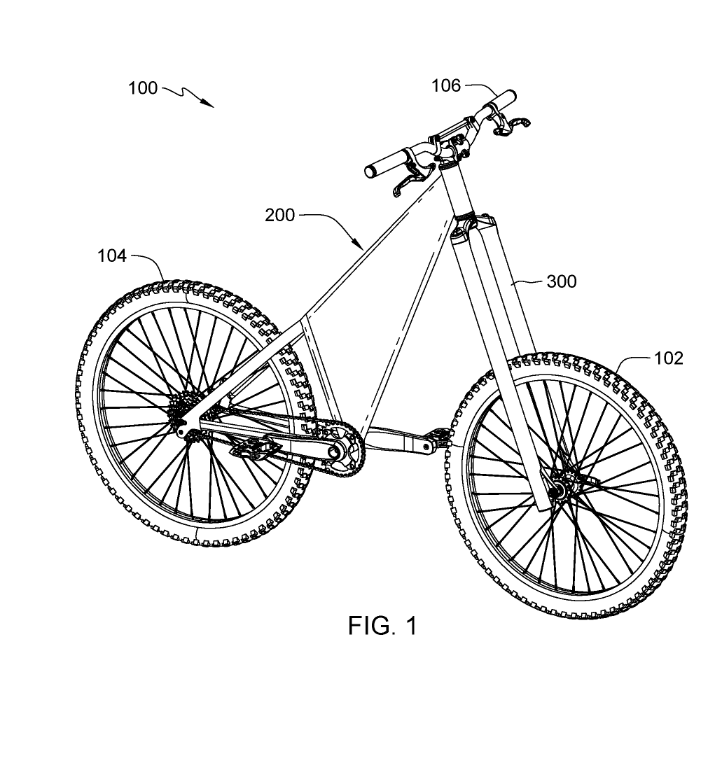

FIG. 1 depicts an isometric view of the standing pedal bicycle 100 (hereinafter “bicycle”), in accordance with one embodiment of the present invention. The bicycle 100 like other conventional bicycles comprises a front wheel 102, a rear wheel 104, a frame 200, handle bars 106, a front fork 300, a drivetrain 108, a brake system and other accessorial devices such a stand, a shifting gear system, shock absorbing systems, fenders, lights, and other features that are known to those of skill in the art may be incorporated into the bicycle 100.

Unlike conventional bicycles, the bicycle 100 is modified to provide a more ergonomic design for the rider and the removal of a seat. The rider remains in the standing position during the entire time they are using the bicycle 100. When operating a bicycle in the standing position, there is reduced stress on the knees and legs, it increases the extension range of the leg, and stabilizes the knee. The current design of the bicycle 100 provides a design where the rider is not hunched over and is in an orthostatic position thereby reducing back, neck, and overall body strain.

In the depicted embodiment, the bicycle 100 is comprised of a frame 200 with the front fork 300 inserted through a portion of the frame and the rear wheel 104 attached to the frame 200. A drivetrain 108 is attached to the frame 200 and the rear wheel 104 and the brake system is secured to the frame 200 as in conventional bicycles. The frame 200 may be a unitary constructed element. In additional embodiments, the frame 200 may be made from various individual elements that are joined, fused, attached, or welded together.

The drivetrain 108 may incorporate pedals attached to the drivetrain and the drivetrain attached to the rear wheel 104 to propel the bicycle 100 forward, similar to conventional bicycle pedal systems. In additional embodiments, the drivetrain 108 may be fixed with a single gear ratio, or may have multiple gears for a setup with multiple gear ratios. The drivetrain 108 is comprised of the various components used in conventional bicycles. In other embodiments, the drivetrain 108 may be connected to the front wheel 102. In some embodiments, the element of the drivetrain 108 to switch between gears is integrated into the handle bars 106. In various embodiments, the element to switch between gears may be incorporated into other elements of the bicycle 100. The drivetrain 108 which can be comprised of a rotational pedal design, a reciprocating motion pedal design, or other pedal designed used in conventional bicycles.

The brake system which can be comprised of a braking device in communication with the front and/or rear wheels 102 and 104, and the associated activation device attached to the handle bars 106 or integrated into the drivetrain 108.

The handle bars 106 in the depicted embodiment are similar to handle bars on a mountain bicycle design. Various other handle bar designed may be incorporated into the bicycle 100 based on the rider preference.

The front wheel 102 and the rear wheel 104 are similar to those used in conventional bicycles. In the depicted embodiment, the wheels 102 and 104 are substantially the same size and are similar to those wheels used on a mountain bicycle to provide additional grip in dirt and grass. In additional embodiments, the size of the wheels 102 and 104 and the tread designs of the wheels 102 and 104 may be varied based on the intended use of the bicycle 100. For example, if the bicycle 100 is used primarily on roads, trails, or in the snow the appropriate wheels may be replaced. Additionally, wheels of various and different sizes may be used to further increase the versatility of the bicycle 100 and to adjust the ride height.

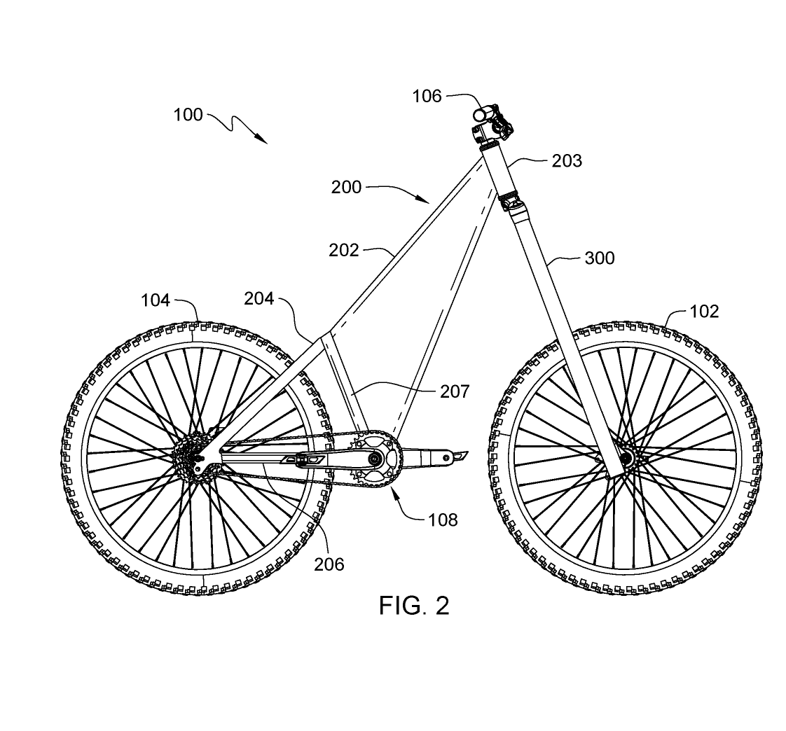

FIG. 2 depicts a side view of the bicycle 100, in accordance with one embodiment of the present invention. In the depicted embodiment, the frame 200 is comprised of a main member 202, a front member 203, an upper rear member 204, and a lower rear member 206. In various embodiments, the frame 200 may be a unitary design comprising these elements, or the frame 200 may be constructed of each of these elements individually that are attached, welded, jointed, or secured to one another.

The frame 200 and each of the elements of the frame 200 may be made from various materials such as steel, aluminum alloys, titanium, carbon fiber, thermoplastics, magnesium, scandium, beryllium, bamboo, wood, or a combination of these and other materials. In some embodiments, various elements of the frame 200 are made from different materials.

In the depicted embodiment, the main member 202 is a solid element to provide the structural rigidity to the bicycle 100, and connects the front member 203 to the rear upper member 204 and rear lower member 206. The main member 202 may be different sizes and shapes based on the intended height of the rider. In the depicted embodiment, the main member 202 has a curved upper edge to allow for the rider to operate the bicycle 100 without their main member 202 interfering with the rider when they are using the bicycle 100 or standing with their feet on the ground. In some embodiments, the main member 202 is between twenty (20) and twenty-nine (29) inches in length. In one embodiment, the main member 202 is attached to a vertical member, which is attached to the rear upper member 204 and the rear lower member 206.

The front member 203 is a hollow tube to allow the front fork 300 to pass through the front member 203 and attached to the handle bars 106. The edge of the main member 202 is set at a predetermined angle, so that when the front member 203 is attached to the main member 202, the front wheel 102 is a predetermined distance from the rear wheel. In one embodiment, the distance between the front wheel 102 and rear wheel 104 is forty (40) inches. The length of the front member 203 is at least the length of the edge of the main member 202 which the front member 203 is attached to.

The upper rear member 204 and the lower rear member 206 are sized and angled so that the rear wheel 104 will rotate without any obstruction, and the braking system can be installed and operate efficiently. In the depicted embodiment, the upper rear member 204 and the lower rear member 206 are forked to contain the rear wheel 104 between each of the prongs of the members 204 and 206.

The front fork 300 is comprised of the steerer, crown, blade, and dropout, similar to conventional bicycle forks. A portion of the front fork 300 passes through the front member 203 of the frame 200, to attached to the handle bars 106. In the depicted embodiment, the blade is elongated to accommodate the frame 200 design, and the desired height of the handle bars 106. In additional embodiments, the front fork 300 has an offset from the central axis of the steerer to the dropout of the blade. The front fork 300 may have integrated shock absorbers, or other forms of suspension to further increase the comfort level of the bicycle over uneven terrain.

The fork 300 may be made from various materials such as steel, aluminum alloys, titanium, carbon fiber, thermoplastics, magnesium, scandium, beryllium, or a combination of these and other materials known to those skilled in the arts.

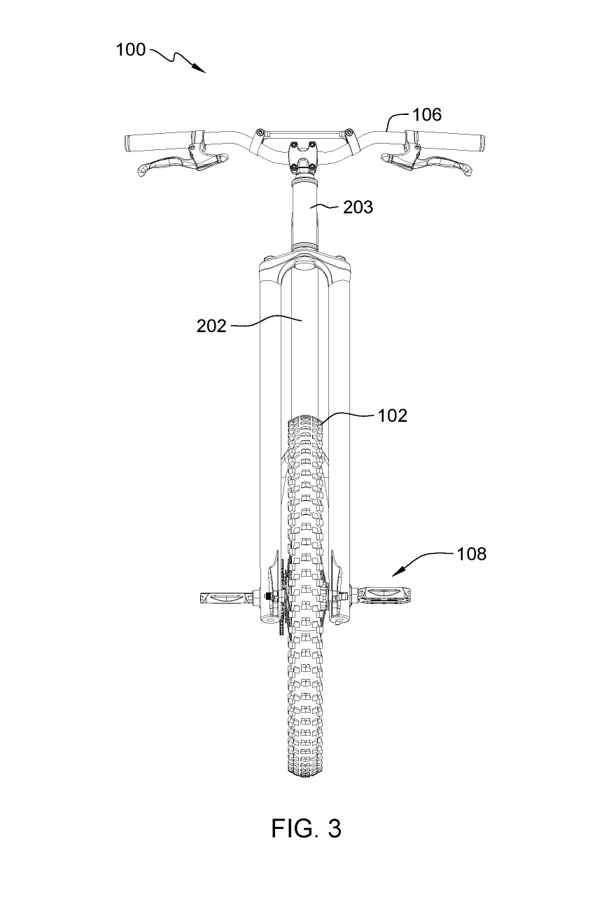

FIG. 3 depicts a front view of the standing pedal bicycle 100, in accordance with one embodiment of the present invention. In the depicted embodiment, the front fork 300 is shown to have a large gap between the front wheel 102 and where the two prongs of the fork connect. In additional embodiments, this gap may be decreased and a larger portion of the front fork 300 is a single element.

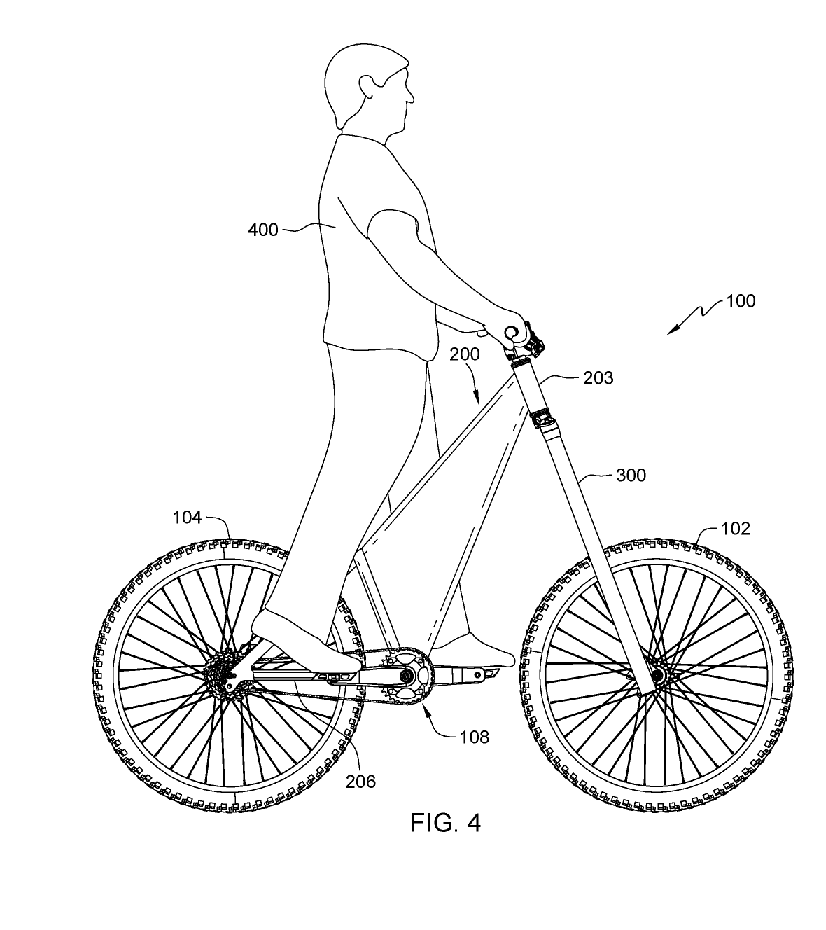

FIG. 4 depicts a side view of the bicycle 100 with a rider 400 on the bicycle 100, in accordance with one embodiment of the present invention. In the depicted embodiment, the rider 400 is shown in an orthostatic position while operating the bicycle 100. This position provides improved ergonomics than the seated or hunched over position required to operate most bicycles. The rider 400 when using the bicycle 100 has the handle bars 106 positioned at approximately their navel. This is a desired position, but based on the pedal height relative to the handle bar 106 height, this may be adjusted. This orthostatic position provides a reduction in stress on the knees, legs, and back of the rider 400 allowing for longer riding times without discomfort. The rider 400 has an improved range of motion of the legs, and the orthostatic position provides an increased in stability of the knee and co-contraction between the quads and the hamstrings thereby stabilizing the knee joint. These benefits are not possible when the rider 400 is using a conventional seated bicycle.

The bicycle 100 permits the rider 400 to have their body weight positioned over the pedals allowing for an increase in the production of power. This position also improves the rider's 400 stability on the bicycle 100 because their weight is positioned over their feet. In variations, the rider 400 may be leaning forward to provide improved balance and forward movement. The frame 200 is design to allow for the rider 400 to easily mount and dismount, because the frame is designed in a way to be unobtrusive to the rider 400. The curved designed, and low profile allows the user to quickly and easily dismount the bicycle 100. The bicycle 100 is set to allow for the rider 400 to be in the standing position without the need to hunch to hold onto the handle bars 106 while also being able to easily mount the bicycle 100 when ready to begin riding again.

The depicted embodiment, shows a rider 400 on the bicycle 100, and when the rider 400 is not on the bicycle 100 they are still able to comfortably and easily hold onto the handle bars 106.

In the depicted embodiment, the wheelbase of the bicycle 100 provides a stable design so that the rider 400 has ample control and a controllable turning radius. In various embodiments, the wheelbase may be increased or decreased based on the rider's 400 desired preferences. For example, a road bicycle may have a wider wheelbase to provide improved cruising speeds, while a mountain bicycle may have a smaller wheelbase to improve the turning radius of the bicycle 100.

The distance from the handle bars 106 to the pedals is dependent upon the rider 400. Thus various sizes of the bicycle 100 are possible based on the height of the rider 400. In some embodiments, the frame 200 or the front fork 300 may be adjustable to provide a more customized and versatile experience for the rider 400. This adjustability may be accomplished by elements of the frame 200 or the front fork 300 having telescopic members integrated with locking mechanisms.

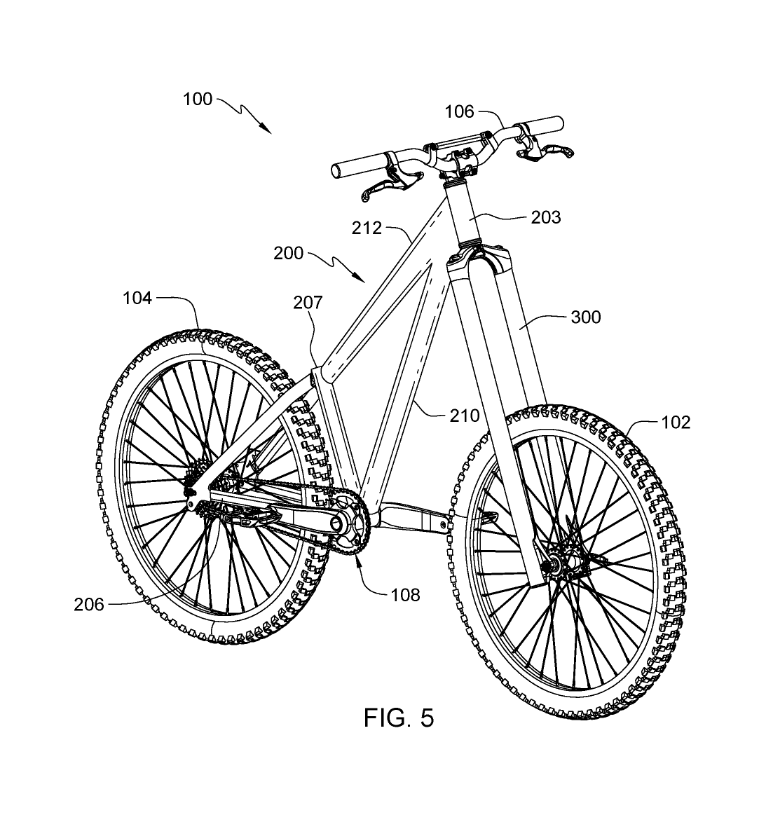

FIG. 5 depicts a side view of the bicycle 100 with a tubular frame, in accordance with one embodiment of the present invention. In the depicted, the frame 200 is comprised of a front upper member 212, a front lower member 210, a vertical member 207, a rear upper member 204, a rear lower member 206, and a handlebar member 203. The rear upper member 204 and the rear lower member 206 are sized to permit the rear wheel 104 to have the necessary space to rotate without coming into contact with the frame 200 or various other elements of the bicycle 100 and also to permit adequate space for the chain to connect the various elements of the drivetrain 108. The vertical member 207 is sized to connect the front upper member 212, the front lower member 210, the rear upper member 204, and the rear lower member 206 while also keeping the frame 200 from interfering with the rider while in the standing position. In the depicted embodiment, the vertical member 207 is shorter than the height of the wheels 102 and 104 so that while the rider is standing they are not coming in contact with the vertical member 206. In additional embodiments, the vertical member 207 is not present. The height of the vertical member 207 is determined by the overall height of the bicycle 100.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention. The present invention shall be easily carried out by an ordinary skilled person in the art, and any modifications and changes are deemed to be within the scope of the present invention.

What is claimed is:

1. A bicycle, comprising:
a front wheel;
an elongated fork having a first end and a second end, wherein the front wheel is attached to the second end of the fort;
a handle bar, wherein the handle bar is freely attached to the first end of the fork to allow a rider to steer the bicycle;
a frame attached to the fork distal to the first end;
a rear wheel attached to the frame;
a drivetrain, wherein the drivetrain is connected to the frame and the rear wheel and allows the rider to propel the bicycle forward;
wherein, the plurality of elongated tubes of the frame position the handle bars relate to the drivetrain so that a rider is in the orthostatic position.

2. The bicycle of claim 1, wherein the drivetrain and the handle bars are positioned so that the rider is in a predetermined deviation from the orthostatic position.

3. The bicycle of claim 1, wherein the frame is comprised of:
a fork tube,
a front upper tube having a first end and second end, wherein the first end of the front upper tube attached to the fork tube,
a front lower tube having a first end and a second end, wherein the first end of the front lower tube attached to the fork tube,
a vertical tube having a first end and a second end, wherein the second end of the front upper tube is attached to the first end of the vertical tube and the second end of the front lower tube is attached to the second end of the vertical tube,
a rear upper tube having a first end and a second end, wherein the first end of the rear upper tube is attached to the first end of the vertical tube, and
a rear lower tube having a first end and a second end, wherein the first end of the rear lower tube is attached to the second end of the vertical member and the second end of the rear lower tube is attached to the second end of the rear upper tube.

4. The bicycle of claim 3, wherein the front upper tube and the front lower tube are sized so the standover of the bicycle positions the handle bars at a height so that when the rider operates the drivetrain, the handle bars require the rider to be in an orthostatic position.

5. The bicycle of claim 1, wherein the frame is made from aluminum.

6. The bicycle of claim 3, wherein the front upper frame tube and the lower front frame tube are telescoping.

7. The bicycle of claim 6, wherein the front upper frame tube having locking mechanisms to secure the front upper frame tube in a permanent position.

8. The bicycle of claim 6, wherein the front lower frame tube having locking mechanisms to secure the front lower frame tube in a permanent position.

9. The bicycle of claim 1, where the elongated fork and the frame form predetermined wheel based for the rider.

10. The bicycle of claim 3, wherein the vertical tube is a predetermined length to permit the rider to operate the bicycle in an orthostatic position.

11. The bicycle of claim 1, wherein the frame is comprised of:
a fork tube,
a solid upper member having a first end and a second end, wherein the first end is connected to the fork tube,
a rear upper tube having a first end and a second end, wherein the first end of the rear upper tube is attached to the second end of the solid upper member, and
a rear lower tube having a first end and a second end, wherein the first end of the rear lower tube is attached to the second end of the vertical member and the second end of the rear lower tube is attached to the second end of the solid upper member.

12. A bicycle, comprising:
a front wheel;
an elongated fork having a first end and a second end, wherein the front wheel is attached to the second end of the fort;
a handle bar, wherein the handle bar is for freely attached to the first end of the fork to allow a rider to steer the bicycle;
a frame attached to the fork distal to the first end, wherein the frame comprises;
a fork tube,
a solid upper member having a first end and a second end, wherein the first end is connected to the fork tube,
a rear upper tube having a first end and a second end, wherein the first end of the rear upper tube is attached to the second end of the solid upper member, and
a rear lower tube having a first end and a second end, wherein the first end of the rear lower tube is attached to the second end of the vertical member and the second end of the rear lower tube is attached to the second end of the solid upper member.
a rear wheel attached to the frame;
a drivetrain, wherein the drivetrain is connected to the frame and the rear wheel and allows the rider to propel the bicycle forward;
wherein, the plurality of elongated tubes of the frame position the handle bars relate to the drivetrain so that a rider is in the orthostatic position.

13. The bicycle of claim 12, wherein the drivetrain and the handle bars are positioned so that the rider is in a predetermined deviation from the orthostatic position.

14. The bicycle of claim 12, wherein the frame is comprised of:
a fork tube,
a front upper tube having a first end and second end, wherein the first end of the front upper tube attached to the fork tube,
a front lower tube having a first end and a second end, wherein the first end of the front lower tube attached to the fork tube,
a vertical tube having a first end and a second end, wherein the second end of the front upper tube is attached to the first end of the vertical tube and the second end of the front lower tube is attached to the second end of the vertical tube,
a rear upper tube having a first end and a second end, wherein the first end of the rear upper tube is attached to the first end of the vertical tube, and
a rear lower tube having a first end and a second end, wherein the first end of the rear lower tube is attached to the second end of the vertical member and the second end of the rear lower tube is attached to the second end of the rear upper tube.

15. The bicycle of claim 14, wherein the front upper tube and the front lower tube are sized so the standover of the bicycle positions the handle bars at a height so that when the rider operates the drivetrain, the handle bars require the rider to be in an orthostatic position.

16. The bicycle of claim 12, wherein the frame is made from aluminum.

17. The bicycle of claim 14, wherein the front upper frame tube and the lower front frame tube are telescoping.

18. The bicycle of claim 17, wherein the front upper frame tube having locking mechanisms to secure the front upper frame tube in a permanent position.

19. The bicycle of claim 17, wherein the front lower frame tube having locking mechanisms to secure the front lower frame tube in a permanent position.

20. The bicycle of claim 12, where the elongated fork and the frame form predetermined wheel based for the rider.
